(19) United States
(12) Patent Application Publication
(10) Pub. No.: US 2013/0083077 A1
(43) Pub. Date: Apr. 4, 2013

(54) METHOD OF DISPLAYING A DIGITAL CONTENT ON A SCREEN

(71) Applicant: France Telecom, Paris (FR)

(72) Inventors: Vincent Auvray, Tonneville (FR); Yunus Arslan, Caen (FR); Remi Groult, Caen (FR)

(73) Assignee: FRANCE TELECOM, Paris (FR)

(21) Appl. No.: 13/629,215

(22) Filed: Sep. 27, 2012

(30) Foreign Application Priority Data
Sep. 29, 2011 (FR) 11 58765

(51) Int. Cl. G09G 5/00

(52) U.S. Cl. 345/660; 345/619

(57) ABSTRACT

A method and apparatus are provided for displaying digital content on a screen of a terminal. The method includes a step of creating zones derived from the content; and a step of displaying the zones in succession on the screen.

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The disclosure relates to a method of displaying a digital content on a screen.

The disclosure applies to any digital content suitable for being displayed on a screen of a terminal.

It should be recalled that a terminal comprises physical and software resources that include a processor suitable for processing digital data. The disclosure applies more particularly to terminals having a screen of a size that is such that displaying the content in full requires the content to be moved on the screen.

### BACKGROUND OF THE DISCLOSURE

The reading of digital contents on the screens of portable computers such as mobile telephones of the smartphone type is experiencing a period of strong growth. This growth began with digital books or “e-books”.

The diversification of contents makes it possible nowadays to purchase newspapers, magazines, . . . and to read those contents on screens of small size.

The contents in question have retained the format of contents on paper. The problem is that the screen in the great majority of portable computers is of a size that is smaller than a content. The step of reading digitized large-format content on small screens, e.g. screens having a diagonal of four inches, therefore assumes that fluid and ergonomic capabilities are available for zooming and moving the contents.

Furthermore, the greater the size of the content and the smaller the size of the screen, the greater the amount the content needs to be manipulated, and thus reading the content becomes complex and frustrating for a user.

An exemplary embodiment of the present disclosure provides a solution that does not present the drawbacks of the state of the art.

### SUMMARY

To this end, in a functional aspect, the disclosure provides a method of reading a digital content on a screen of a terminal, wherein the method comprises the following steps:
a step of creating zones derived from the content; and
a step of displaying the zones in succession.

According to an embodiment of the disclosure, a digital content is subdivided into zones, it being possible for each zone to be read individually and in succession. Thus, by means of a prior zone-creation step, an embodiment of the disclosure offers the advantage of being able to consult a content by viewing each zone individually and continuously. An embodiment of the disclosure thus avoids manipulations during the display of a content and thus while it is being read.

Zoning also makes it possible to conserve the original appearance of the content. Once the zones have been created, they are not modified. In other words, if a content is in a given format, e.g. PDF, the format of the created zone remains the same.

In a particular implementation, a zone is associated with a respective zoom level so as to display the zones with their respective zoom levels. Thus, while displaying the content, the zones are displayed one after another with respective appropriate zoom levels. The display is thus improved since the zones are displayed without the user needing to move the content on the screen, in particular when the content is of a size that is greater than the screen. Furthermore, the zoom level is preferably selected in such a manner that the user can read the zone and thus the characters displayed.

In a second particular implementation, that may be implemented as an alternative to or together with the above implementation, for each zone to be displayed, the step of displaying zones comprises the following substeps:
a substep of performing an approach effect in order to display a zone with the predefined zoom level associated with the zone in question;
a display substep during which the zone scrolls on the screen at a given speed;
followed, after the display, by a substep of performing an effect of distancing the displayed zone.

While displaying the content, in particular on passing from one zone to another, this second implementation serves to locate the zone within the content.

It is specified at this point that an effect of approaching and/or distancing a zone, or more generally a content, has the consequence respectively of magnifying and/or shrinking the zone or the content in question on the screen.

In a third particular implementation, that may be implemented as an alternative to or together with the above implementations, the zone and the screen are both of rectangular shape, each having two respective vertical sides and two respective horizontal sides. In this configuration, if the horizontal side of the zone is longer than the horizontal side of the screen, the zone is caused to scroll along a horizontal axis. In this way, a user can view the zone without needing to take a horizontal axis scroll action.

In a fourth particular implementation that may be implemented as an alternative to or together with the above implementations, the zones are displayed in succession in the same order as the zones were selected during the creation step. Thus, zone creation may advantageously be performed, e.g. in order of preference.

In a hardware aspect, an embodiment of the disclosure also provides a terminal including a screen for displaying a digital content, wherein the terminal includes:
means for creating zones derived from the content; and
means for displaying the zones in succession.

In another hardware aspect, an embodiment of the disclosure also provides a computer program suitable for being performed on a terminal as defined above, said program including code instructions that, when the program is executed by a processor, perform the steps of the above-defined method, namely:
a step of creating zones derived from the content; and
a step of displaying the zones in succession.

The present disclosure can be better understood on reading the following description given by way of example and made with reference to the accompanying drawings.

### BRIEF DESCRIPTION OF THE DRAWINGS

FIG. 1 shows a computer system on which the an embodiment of the disclosure can be implemented.

FIG. 2 is a view of a content having the above-defined zones shown thereon.

FIG. 3 is a diagrammatic view of the size of a content relative to a screen.

FIG. 4 is a flow chart showing the various steps of an implementation of the method of the disclosure.

FIGS. 5a to 5c show three screen views in which zones are displayed while displaying the content.

FIG. 6 is a flow chart showing the various steps of another implementation of the method of the disclosure.

FIG. 7 is a flow chart showing the various steps of another implementation of the method of the disclosure.

FIGS. 8 and 9 show respectively another implementation and the resulting displays on the screen.

FIGS. 10 and 11 likewise show respectively another implementation and the displays that result therefrom on the screen.

### DETAILED DESCRIPTION OF ILLUSTRATIVE EMBODIMENTS

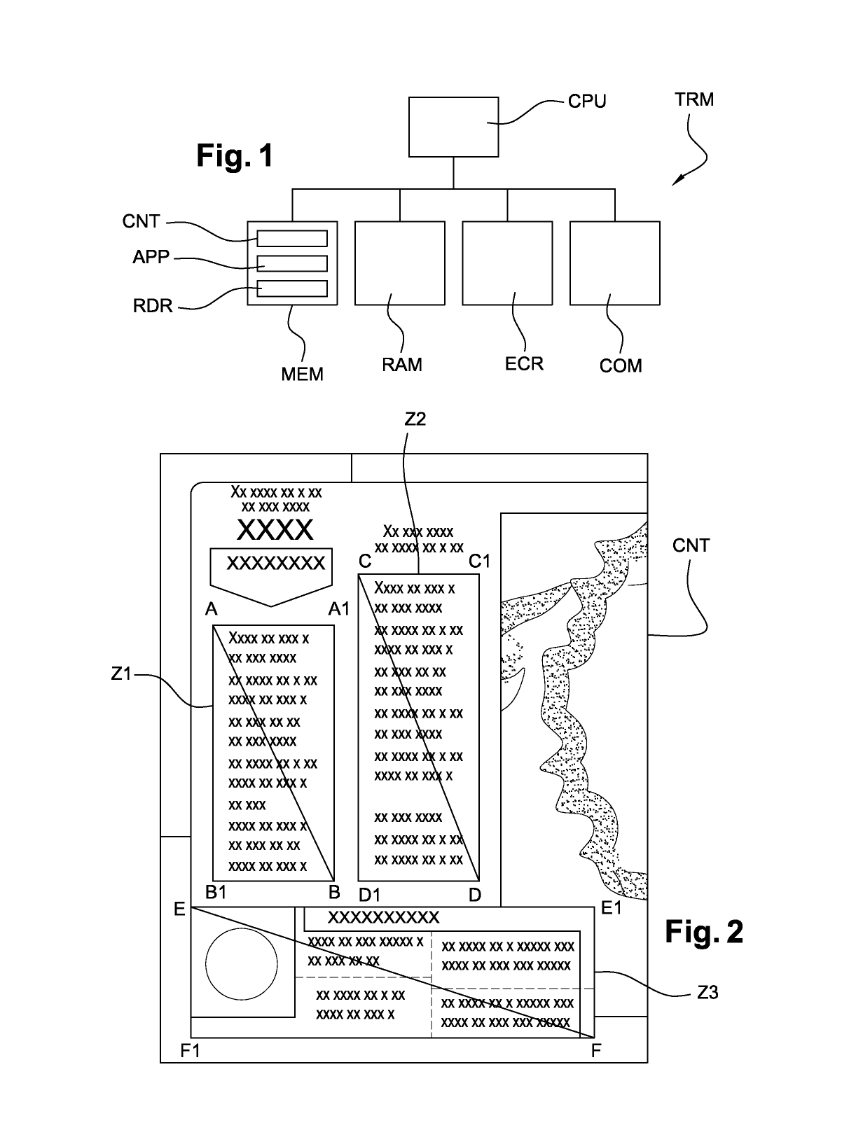

FIG. 1 shows a terminal TRM having a microprocessor CPU connected via a bus BUS to a non-volatile storage memory MEM, a random access memory RAM, a screen ECR, control means CLV such as a keypad, and communications means COM suitable for receiving a content CNT for display.

It should be recalled that an exemplary embodiment of the disclosure applies most particularly to contents that, in order to be read, require the content to scroll on the screen, e.g. under the control of a user, e.g. by manipulating the screen if it is touch sensitive or by acting on the keys of a keypad of the terminal if it has a keypad CLV. Such a content is typically a page in the JPEG format (where JPEG stands for joint photographic experts group), however it could be a page in the PDF format (where PDF stands for portable document format) or in hypertext markup language (HTML) or in extensible HTML (XHTML), or in some other format.

In this example, the content comprises a JPEG page. Naturally, embodiments of the disclosure are not limited to one page but may extend to an unlimited number of pages.

The microprocessor CPU is suitable for controlling the display of a digital content CNT on the screen. For this purpose, the terminal has a reader module RDR suitable for displaying a content on the screen on receiving a display command from the microprocessor CPU. In this example, the reader module RDR is a program suitable for displaying files in a format of the JPEG type.

In order to illustrate an embodiment of the disclosure, and with reference to FIG. 2, it is assumed that the content CNT is of rectangular format. A point of the screen may for example be identified by means of a frame of reference (O,X,Y) in which the unit is one pixel.

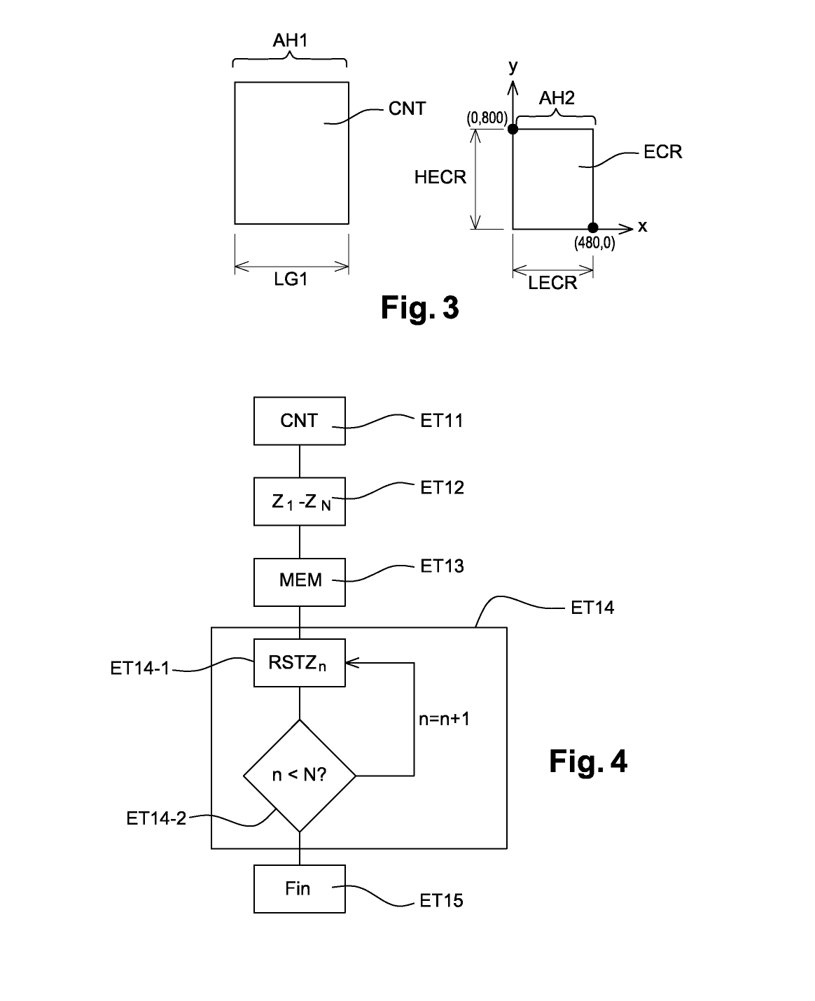

With reference to FIG. 3, it is also assumed that the screen ECR is likewise rectangular and that the length LECR of a horizontal side AH2 of the screen is shorter than the length LG1 of a horizontal side AH1 of the content. In this example, the screen is 480 pixels wide and 800 pixels high. In FIG. 3, the screen is shown in portrait mode.

It is recalled at this point that a screen is said to be in “landscape” mode when the orientation of the screen or the orientation of the display on the screen in three dimensions is such that the height of the screen, or of the content displayed on the screen, is less than its length LECR. FIG. 11 shows this configuration. Conversely, a screen is said to be in “portrait” mode when the orientation of the screen in three dimensions is such that the height of the screen HECR is greater than its length LECR.

It can be understood from the above that consulting a content on the screen ECR requires the content to move or scroll on the screen. Furthermore, consultation may require an effect of approaching or of distancing the content on the screen ECR (zoom effect).

According to an embodiment of the disclosure, in order to avoid content scrolling actions on the screen, a creation step takes place during which zones Z1-Zn are created in the content so as to enable zones to be displayed on the screen in succession. Thus, the zones will be displayed on the screen in succession one after another.

For a user, creation consists in selecting portions of the content CNT.

In this example, the zones that are created are three in number (n=3), namely a first zone Z1, a second zone Z2, and a third zone Z3.

The first Z1 has a top first horizontal side A-A1 and a bottom second horizontal side B-B1.

The second zone Z2 has a first horizontal side C-C1 at the top and a second horizontal side D-D1 at the bottom.

The third zone Z3 has a first horizontal side E-E1 at the top and a second horizontal side F-F1 at the bottom.

Various implementations and associated variants are described below. Each implementation corresponds to steps referenced ETnk, where n specifies the implementation and k specifies the step. Thus, a step may be subdivided into a plurality of other steps that are referred to below as “substeps” and that are referenced ETnk-j, where j designates the substep in question.

It should be observed that n, k, and j are integers.

A first implementation is described below with reference to FIG. 4. This figure shows an algorithm comprising a plurality of steps referenced ET11 to ET15.

During a first step ET11, a content CNT is created that is suitable for being played back. A content is for example a magazine.

In this example, creation involves executing a program APP enabling zones to be created in the content for the purpose of displaying the zones on the screen.

During a second step ET12, zones Z1 to Zn are created. In this example, the three above-described zones Z1 to Z3 are created. Any method may be used for creating a zone. For example, if a computer mouse is used, creation may consist in selecting two points on the screen, e.g. points A and B for the first zone. The program APP then defines the rectangular shape that forms the first zone Z1 (A A1 B B1), or any other geometrical shape, where so desired. A rectangular shape is preferred since most present-day screens are rectangular.

Once the zones have been created, during a third step ET13, the coordinates of the zones are stored in the memory MEM.

After being stored, during a fourth step ET14, the program APP starts to display. During this fourth step ET14, the program RDR is executed; after being executed, the three zones selected during zone creation are displayed in succession one after another, with this taking place automatically. For this purpose, the program thus loops through two substeps ET14-1 and ET14-2 for each zone. In this example, the zones are displayed in succession in the same order as the zones were selected during the creation step.

During a substep ET14-1, a first zone Z1 is displayed on the screen.

After being displayed, during a substep ET14-2, the program RDR determines whether another zone is to be displayed.

If so, the substep ET14-1 is performed again with the following zone, and so on until the last zone, which in this example is the third zone Z3.

In this example, the method ends during a fifth step ET15, after displaying the third zone Z3.

In this example, when the vertical or horizontal side of a zone is longer than the corresponding vertical or horizontal side of the screen, the zone scrolls automatically on the screen either vertically or horizontally, as on a tele-prompt, at a speed that is automatic or that is defined beforehand, e.g. by a user of the terminal.

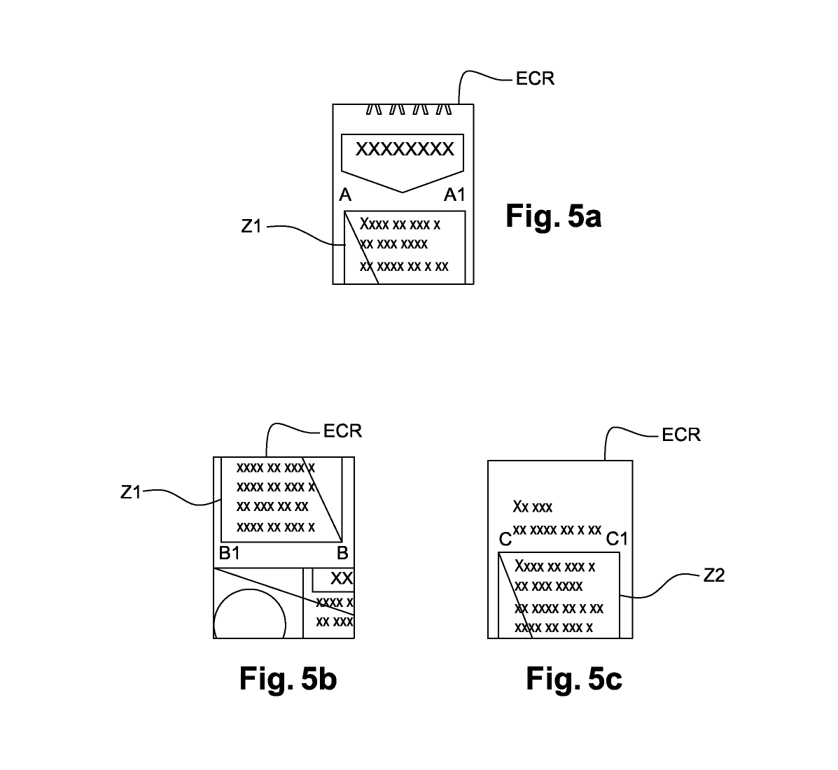

FIGS. 5a to 5c show the situation after an approach effect has been performed, in which the horizontal sides of the zones and of the screen have lengths that match and in which the vertical sides of the zones are longer than the vertical side of the screen. Preferably, a zone remains included in the screen; in other words, the level of zoom is selected so that the horizontal side of a zone is shorter than the horizontal side of the screen.

It is mentioned here that in the context of an embodiment of the disclosure two lengths correspond with each other when they are equal or differ by a few millimeters.

FIG. 5a shows the instant at which the first zone Z1 starts to be displayed. In this example, the side A-A1 of the first zone Z1 is positioned in the center of the screen, but it could be positioned anywhere else on the screen.

Thereafter, the zone scrolls vertically at a predefined speed. FIG. 5b shows the instant corresponding to the end of displaying the first zone Z1. At this instant, the side B1-B of the first zone Z1 is situated near the center of the screen.

Thereafter, after the first zone Z1 has been displayed, the substeps ET41 and ET42 are executed once more for the second zone Z2.

FIG. 5c shows the instant at which the second zone Z2 starts to be displayed. In this example, the side C-C1 of the zone Z2 is positioned at the center of the screen.

In this example, the zones are displayed in succession in the same order as the order in which the zones were selected during the creation step.

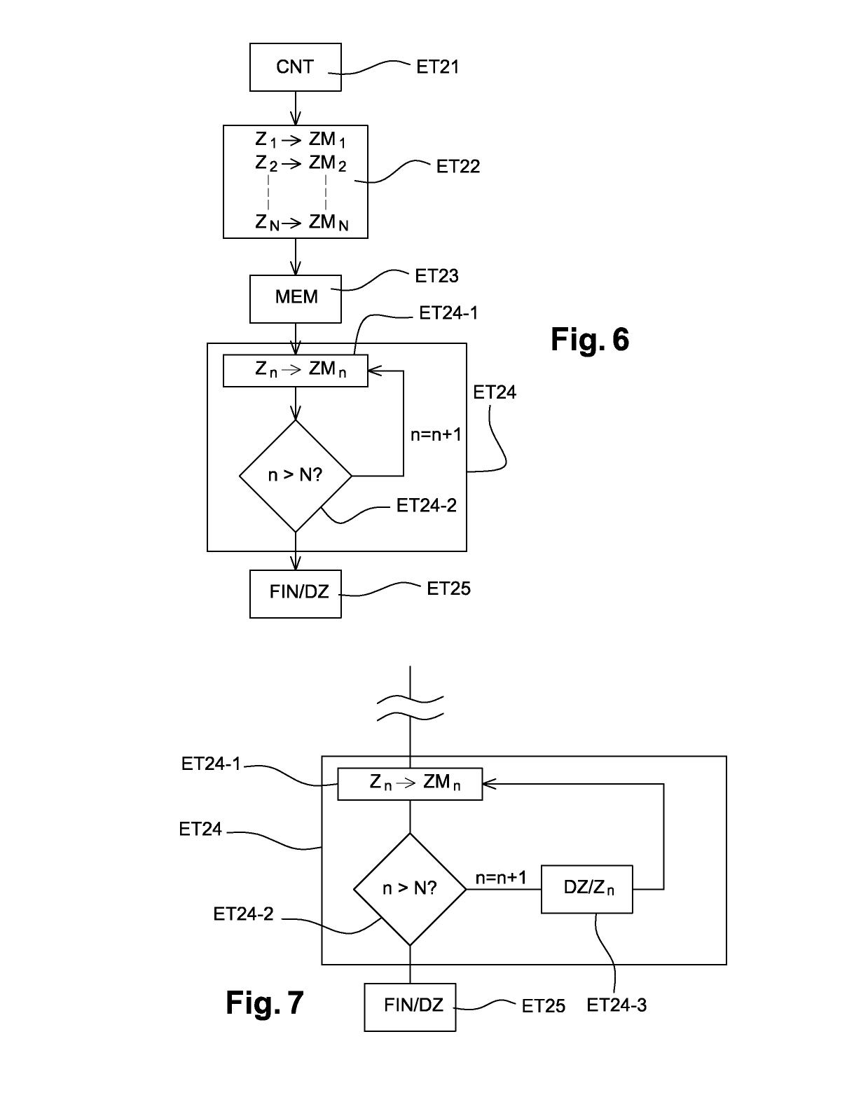

FIG. 6 shows a second implementation that is described below. In this variant, a zone is associated with a respective zoom level so as to display each zone in succession with the zoom level defined for that zone. In this example, the zoom level associated with a zone is selected so that it is possible to read the zone; in other words, a well-selected zoom level enables characters to be displayed at a size that is large enough to make the zone comfortable to read.

In this implementation, the first step ET21 is the same as the first step ET11 of the implementation described with reference to FIG. 4.

In this example, in a second step ET22 of this second implementation, the three created zones Z1 to Z3 correspond to three respective zoom levels, namely a first zoom level ZM1, a second zoom level ZM2, and a third zoom level ZM3.

Once creation has been performed, during a third step ET23 of this second implementation, the coordinates of the zones and their respective zoom levels are stored in the memory MEM.

After storage, and during a fourth step ET24, the program RDR starts the display. During this fourth step, the three created zones are displayed in succession one after another with their respective predefined zoom levels. For this purpose, the program RDR performs two substeps ET24-1 and ET24-2 in a loop for each of the zones.

During a substep ET24-1, a first zone Z1 is displayed with the first zoom level ZM1.

After the first zone Z1 has been displayed, during a substep ET24-2, the program determines whether another zone is to be displayed. If so, the substep ET24-1 is performed again with the following zone Z2, and so on until the last zone Z3 in this example.

In this example, during a fifth step ET25, after displaying the last zone, i.e. the third zone Z3, the display method ends (END).

As stated above, each zone has a zoom level corresponding thereto. In this example, the zoom level is selected as a function both of the horizontal side of the zone to be displayed and of the horizontal side of the screen so that during display those two sides are of approximately the same length.

In a variant that is applicable to both above-described implementations, and with reference to the algorithm of FIG. 7, on passing from one zone to another during a step ET24-3, the program performs a distancing effect followed by an approach effect so as to begin by distancing a zone that has been displayed. Thereafter, in step ET24-1, an approach effect is performed so as to move closer to the following zone that is to be displayed. This effect has the advantage of beginning by showing where the zone that has been displayed is located relative to the content CNT, and then by showing where the following zone that is to be displayed is located relative to the same content CNT. Specifically, the fourth step of the second implementation is modified as follows: a third substep ET24-3 follows the second substep ET24-2 if there remain any zones to be displayed, and the processor performs a distancing effect after displaying the zone and then an approach effect towards the zone that is to be displayed.

In another variant, the zoom automatically adjusts the small dimension of the zone (smaller of horizontal and vertical sides) to the horizontal or vertical dimension of the screen. The zoom level is preferably selected so that the size of the characters to be displayed is sufficient to enable them to be read. If not, the display may be followed by the user reading the zone taking an action, which action may consist in moving towards or away from the zone.

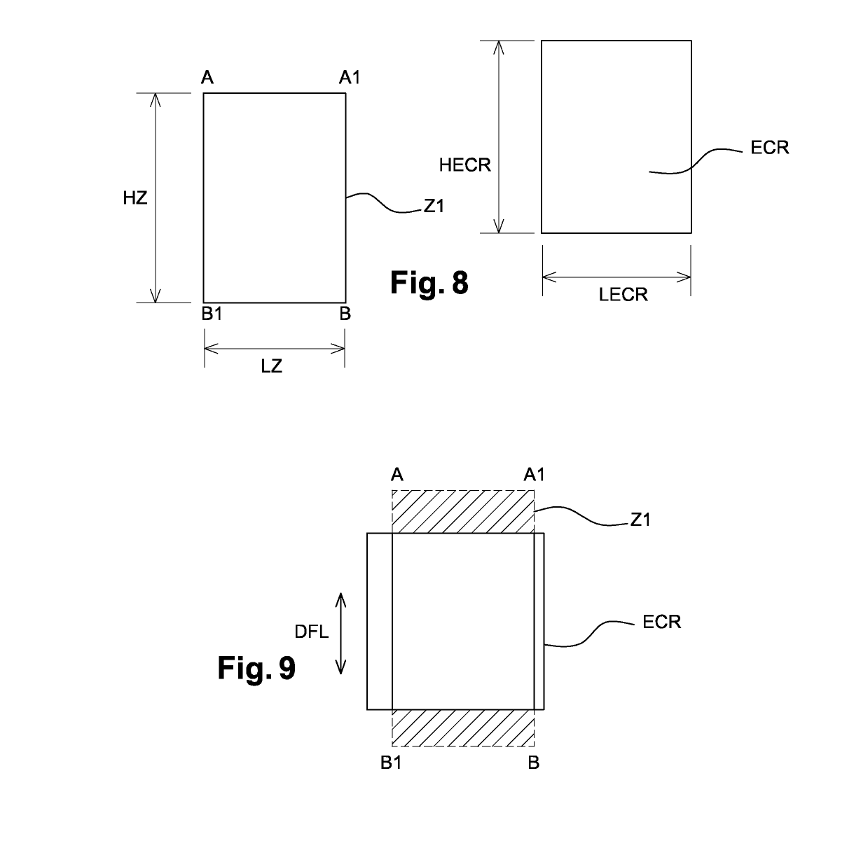

Examples are described with reference to FIGS. 8 to 11. In these figures, the portions of a zone shown with dashed lines and shading represent the portions of a zone that are not displayed on the screen and for which display on the screen requires the zone to be scrolled (or moved) on the screen.

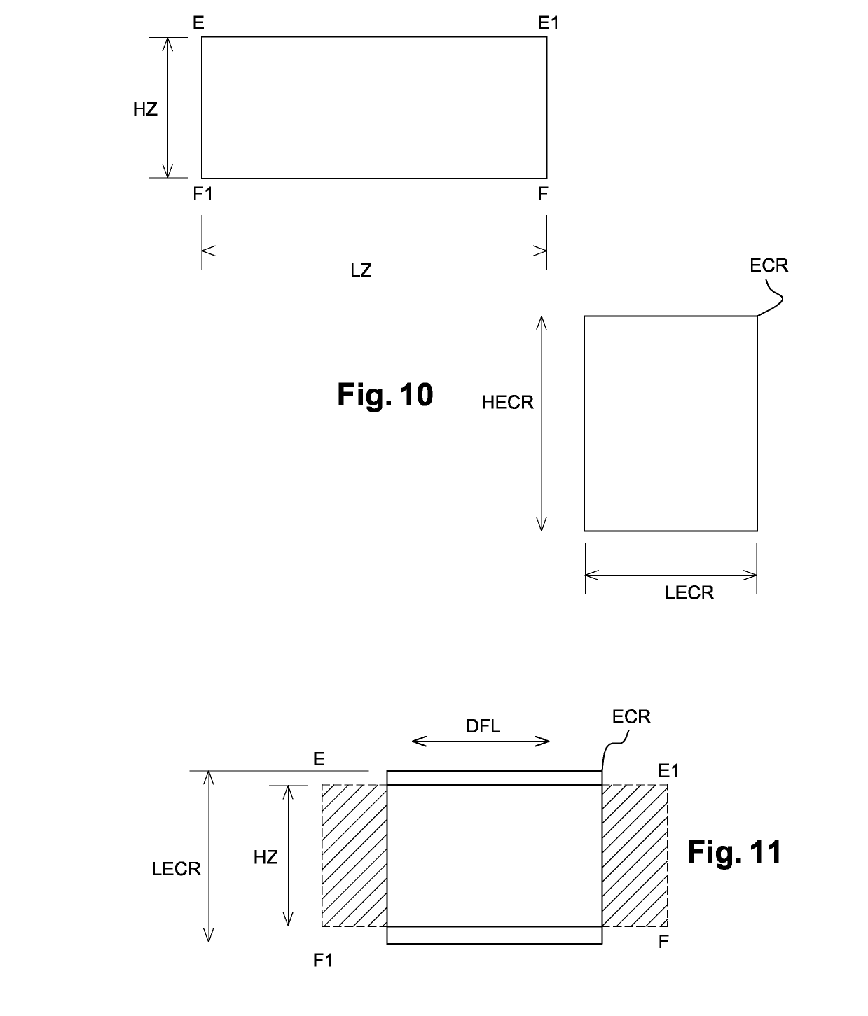

Thus, with reference to FIGS. 8 and 9, if a zone (e.g. the first zone Z1) is of a size such that the length HZ of a vertical side of the zone is greater than the length LZ of a horizontal side, then zooming takes place in portrait mode, ensuring that the horizontal side of the zone is of approximately the same length as the horizontal side of the screen when the screen is in portrait mode, or indeed is shorter. In this configuration, the automatic scrolling DFL of the zone in question is vertical.

Also, in another variant, with reference to FIGS. 10 and 11, if the zone is of a size such that the length HZ of a vertical side of the zone is shorter than the length LZ of the horizontal side of the zone, and if the length of a vertical side of the zone is shorter than the length LECR of a horizontal side of the screen when the screen is oriented in portrait mode, the zone is displayed on the screen in landscape mode. In this configuration, the automatic scrolling DFL is horizontal. In this variant, the zone is that much easier to read since the selected character size can be greater because of using landscape mode. In this configuration, the zone may scroll horizontally.

In order to implement an embodiment of the disclosure, the terminal includes means for performing the following steps:
a substep of performing an approach effect in order to display a zone (Zn) with the predefined zoom level associated with the zone in question;
a display substep during which the zone scrolls on the screen at a given speed;
followed, after the display, by a substep of performing an effect of distancing the displayed zone.

Above the description refers to a zone and a screen that are of rectangular shapes each having two respective vertical sides and two respective horizontal sides. In order to perform the second implementation, the terminal has means for selecting a zoom level so that the horizontal side of a zone is of a length that corresponds to the length of the horizontal side of the screen.

The terminal also includes means for causing a zone to scroll along a horizontal axis if the horizontal side of the zone has a length that is greater than the horizontal side of the screen.

Finally, the terminal also includes means for complying with the order in which the zones were selected during the creation step while displaying the zones in succession.

Although the present disclosure has been described with reference to one or more examples, workers skilled in the art will recognize that changes may be made in form and detail without departing from the scope of the disclosure and/or the appended claims.

1. A method of displaying a digital content on a screen of a terminal, wherein the method comprises the following steps:
a step of creating zones derived from the content with a processor; and
a step of displaying the zones in succession on the screen.

2. A method according to claim 1, wherein a zone is associated with a respective zoom level so as to display the zones in succession with their respective zoom levels.

3. A method according to claim 1, wherein the step of displaying zones comprises, for each zone that is to be displayed, the following steps:
a substep of performing an approach effect in order to display a zone with the predefined zoom level associated with the zone in question;
a display substep during which the zone scrolls on the screen at a given speed;
followed, after the display, by a substep of performing an effect of distancing the displayed zone.

4. A method according to claim 2, wherein a zone and the screen are of rectangular shape, each having two respective vertical sides and two respective horizontal sides, and wherein the zoom level for a zone is selected so that the horizontal side of a zone has a length corresponding to the length of the horizontal side of the screen.

5. A method according to claim 1, wherein a zone and the screen are of rectangular shapes, each having two respective vertical sides and two respective horizontal sides, and wherein if the horizontal side of the zone is longer than the horizontal side of the screen, the zone is caused to scroll along a horizontal axis.

6. A method according to claim 1, wherein the zones are displayed in succession in the same order as the zones were selected during the creation step.

7. A terminal comprising:
a screen for displaying a digital content;
means for creating zones derived from the content; and
means for displaying the zones in succession.

8. A non-transitory computer-readable medium comprising a computer program recorded thereon and including code instructions that, when the program is executed by a processor, cause the processor to perform method of displaying a digital content on a screen of a terminal, wherein the method comprises the following steps:
a step of creating zones derived from the content; and
a step of displaying the zones in succession on the screen.
